(19) United States
(12) Patent Application Publication
(10) Pub. No.: US 2025/0212167 A1
(43) Pub. Date: Jun. 26, 2025

(54) Locating Ambient Power Devices in Wireless Networks

(71) Applicant: Cisco Technology, Inc., San Jose, CA (US)

(72) Inventors: Ugo Campiglio, ECUBLENS (CH); Jerome Henry, Pittsboro, NC (US); Robert Barton, VANCOUVER (CA); Indermeet Gandhi, San Jose, CA (US); Matthew Silverman, Shaker Heights, OH (US)

(21) Appl. No.: 18/798,605

(22) Filed: Aug. 8, 2024

Related U.S. Application Data
(60) Provisional application No. 63/614,898, filed on Dec. 26, 2023.

(51) Int. Cl. H04W 64/00; G01S 13/74; H04W 12/63; H04W 56/00

(52) U.S. Cl. CPC H04W 64/003; G01S 13/74; H04W 12/63; H04W 56/001

(57) ABSTRACT

Devices, systems, methods, and processes for locating ambient power (“AMP”) devices in a wireless network are described herein. In the wireless network, locations of various network devices are known. When an AMP device enters the wireless network, timing synchronization function (“TSF”)-based timestamping and relay by other known network devices of the wireless network are utilized to detect the location of an AMP device in the wireless network. The process includes an AMP device transmitting a message timestamped with AMP's TSF value to the network device, and the network device recording a time-of-arrival of the message using its TSF value. Both the network device and the AMP device are synchronized with a location detector (e.g., an access point) that utilizes these timestamps to detect the location of the AMP device. The TSF time-stamping process is simpler, consumes less airtime, and has lower frame processing complexity than conventional ranging protocols.

The present disclosure relates to wireless networking. More particularly, the present disclosure relates to locating ambient power devices in wireless networks.

This application claims the benefit of U.S. Provisional Patent Application No. 63/614,898, filed Dec. 26, 2023, which is incorporated by reference herein in its entirety.

### BACKGROUND

Wireless networks are communication systems that transmit data over radio waves, enabling devices to connect and communicate without the need for physical cables. This technology has revolutionized communication in the digital world, providing the backbone for various modern conveniences. Wireless networks enable devices such as smartphones, laptops, tablets, smart televisions, or the like, to connect to the Internet and communicate with each other.

Wireless networks can operate through different standards and frequencies, with Wireless Fidelity (“Wi-Fi”), Bluetooth, and cellular networks being the most common. Wi-Fi networks can provide high-speed internet access in homes, offices, and public spaces for everyday activities such as web browsing, streaming, and online collaboration. Cellular networks can offer wide-area coverage and high-speed mobile internet, supporting mobile communication, location-based services, or the like. Bluetooth is used for short-range communication in wireless headphones and speakers, hands-free car systems, fitness trackers, or the like.

For efficient and seamless communication between various devices, determining the physical location of such devices within a wireless network can be important. Such localization can be utilized in a variety of applications. For example, it can enable precise location tracking of devices within the wireless network for navigation, asset tracking, and geofencing. Additionally, wireless positioning can enhance the security and management of the wireless network. By accurately identifying the location of connected devices, network administrators can detect unauthorized access or suspicious activities more effectively. This can prevent security breaches and ensure compliance with regulatory requirements.

### SUMMARY OF THE DISCLOSURE

Systems and methods for locating ambient power devices in wireless networks in accordance with embodiments of the disclosure are described herein. In some embodiments, a device includes a processor, a network interface controller configured to provide access to a network, and a memory communicatively coupled to the processor, wherein the memory includes a location detection logic that is configured to obtain a timestamp value from at least one network device, wherein the timestamp value is configured to indicate a time-of-arrival of a target message, from a target device, at the at least one network device, and wherein the target device is associated with a processing delay, determine a distance between the target device and the at least one network device based on the obtained timestamp value and the processing delay, and detect a location of the target device in the network based on a location of the at least one network device in the network and the distance between the target device and the at least one network device.

In some embodiments, the target device corresponds to an ambient power device.

In some embodiments, prior to transmission of the target message, a timing synchronization function (“TSF”) value of the target device is synchronized with a TSF value of the device.

In some embodiments, the location detection logic is further configured to transmit, to the target device, a beacon that is configured to indicate the TSF value of the device.

In some embodiments, the processing delay corresponds to a time duration between the TSF synchronization at the target device and the transmission of the target message.

In some embodiments, a TSF value of the at least one network device is synchronized with a TSF value of the device.

In some embodiments, the location detection logic is further configured to transmit, to the at least one network device, a beacon that is configured to indicate the TSF value of the device.

In some embodiments, determining the distance between the target device and the at least one network device based on the obtained timestamp value and the processing delay includes determining a time-of-travel of the target message from the target device to the at least one network device based on the obtained timestamp value and the processing delay, and wherein the distance between the target device and the at least one network device is determined based on the time-of-travel of the target message.

In some embodiments the location detection logic is further configured to determine a TSF error at the target device, and wherein the location detection logic determines the time-of-travel of the target message further based on the TSF error at the target device.

In some embodiments, the location detection logic is further configured to obtain a TSF value of the target device, and wherein the location detection logic determines the TSF error at the target device based on the TSF value of the target device, the processing delay, and a TSF value of the device.

In some embodiments, the target message includes one or more frames configured to indicate at least one timing attribute of the target device.

In some embodiments, the target message corresponds to a probe request configured to indicate at least one timing attribute of the target device.

In some embodiments, the location detection logic is further configured to obtain the processing delay associated with the target device from the at least one network device.

In some embodiments, the location detection logic further determines the distance between the target device and the at least one network device based on a received signal strength indicator (“RSSI”) of the target message.

In some embodiments, the location detection logic detects the location of the target device further based on a distance between the device and the target device.

In some embodiments, the location detection logic is further configured to obtain a distance between the device and the at least one network device, and determine the distance between the device and the target device based on the determined distance between the target device and the at least one network device and the obtained distance between the device and the at least one network device.

In some embodiments, a location detection logic is configured to receive a target message from a target device, record a time-of-arrival of the target message based on a TSF value of the device, synchronize the TSF value of the device with a TSF value of a network device, and update the recorded time-of-arrival of the target message based on the synchronized TSF value of the device, wherein the updated time-of-arrival of the target message is configured to facilitate detection of a location of the target device in the network.

In some embodiments, the location detection logic is further configured to determine a processing delay associated with the target device, and wherein the processing delay is configured to facilitate the detection of the location of the target device in the network.

In some embodiments, the target message is configured to indicate a basic service set identifier (“BSSID”) of the network device, and based on the BSSID of the network device, the TSF value of the network device is utilized for the synchronization of the TSF value of the device.

In some embodiments, a method includes obtaining a timestamp value from at least one network device, wherein the timestamp value is configured to indicate a time-of-arrival of a target message, from a target device, at the at least one network device, and wherein the target device is associated with a processing delay, determining a distance between the target device and the at least one network device based on the obtained timestamp value and the processing delay, and detecting a location of the target device in a network based on a location of the at least one network device in the network and the distance between the target device and the at least one network device.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic block diagram of a wireless local networking system in accordance with various embodiments of the disclosure;

FIG. 2 is a conceptual depiction of a communication layer architecture in accordance with various embodiments of the disclosure;

FIG. 3 is a conceptual network diagram of various environments that a location detection logic may operate within in accordance with various embodiments of the disclosure;

FIG. 4 is a networking environment for location detection of ambient power (“AMP”) devices in accordance with various embodiments of the disclosure;

FIG. 5 is a conceptual sequence diagram that illustrates an AMP device location detection operation in accordance with various embodiments of the disclosure;

FIG. 6 is a flowchart depicting a process for determining a distance between a target device and a network device in accordance with various embodiments of the disclosure;

FIG. 7 is a flowchart depicting a process for locating a target device in a wireless network in accordance with various embodiments of the disclosure;

FIG. 8 is a flowchart depicting a process for facilitating target device location detection in accordance with various embodiments of the disclosure;

FIG. 9 is a flowchart depicting a process for target device processing in accordance with various embodiments of the disclosure; and

FIG. 10 is a conceptual block diagram for one or more devices capable of executing components and logic for implementing the functionality and embodiments described above.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In the present disclosure, devices and methods are discussed that detect locations of ambient power (“AMP”) devices in a wireless network using locations of other network devices of the wireless network. With advancements in the field of energy harvesting and sustainability, wireless networks have seen a rise in AMP devices. AMP may refer to the practice of harnessing energy from the surrounding environment to power devices, often with minimal or no reliance on traditional batteries or wired electricity. Examples of the AMP devices may include, but are not limited to, solar-powered Wi-Fi Access Points (“APs”), thermal energy harvesting sensors, Radio Frequency (“RF”) energy harvesting devices, piezoelectric energy harvesting units, ambient light-powered indoor sensors, and small-scale wind energy harvesting devices.

The AMP devices can thus play a transformative role in the wireless networks by providing a sustainable and maintenance-free energy source for a multitude of wireless sensors and devices. In the wireless networks, especially in the context of the Internet of Things (“IoT”), the deployment of numerous sensors and devices can enable gathering data, monitoring conditions, and enabling communication. Traditionally, these devices rely on batteries, which may require regular replacement or recharging, posing logistical challenges and increasing operational costs. The AMP devices, however, can harvest energy from the environment thus reducing or even eliminating the need for battery replacements. This can not only enhance the reliability and lifespan of the wireless networks but can also make them more cost-effective and environmentally friendly. Moreover, the integration of the AMP devices into the wireless networks can enhance the scalability and resilience of the wireless networks. For example, these devices can operate autonomously in remote or hard-to-reach locations, where regular maintenance can be difficult.

Given the role the AMP devices play in the wireless networks, it may be important to accurately locate the AMP devices in the wireless networks for optimizing their performance and efficiency. Additionally, the accurate location of the AMP devices may enhance the overall network performance and data accuracy. Conventionally, the wireless network space is swept with radio beams to detect AMP devices and their locations. However, such an approach may not yield accurate results and may impact the efficiency and performance of the network operations.

To solve the aforementioned issue, in the present disclosure, a location detection operation is described that uses timing synchronization function (“TSF”)-based timestamping and relay by other network devices of the wireless network to detect the location of an AMP device. In the present disclosure, the locations of the other network devices are known, and hence, can be utilized for assisting the AMP device location detection operation. The TSF time-stamping process is simpler, consumes less airtime, and has lower frame processing complexity than conventional ranging protocols.

In the present disclosure, an AP supporting a plurality of devices including the AMP devices, may detect locations of the AMP devices in the wireless network using the other network devices of the wireless network. Examples of the other network devices may include other APs, wireless stations, or the like. The other network devices of the wireless network that assist in the AMP device location detection operation are hereinafter referred to as “buddy devices”. The buddy devices may thus act as relays for the AMP device energy harvesting and frame detection. To enable the location detection, the AP, the buddy devices, and the AMP devices may utilize associated location detection logic.

In still further embodiments, the location detection logic of the AP (hereinafter referred to as an “AP location detector”) may be configured to transmit a beacon to an AMP device. The beacon may be configured to indicate a TSF value of the AP. In still additional embodiments, each of the AP, the AMP device, and the buddy devices may include a TSF timer. In such cases, a TSF value may correspond to a value of the TSF timer.

The location detection logic of the AMP device (hereinafter referred to as “AMP location detector”) may be configured to receive the beacon transmitted by the AP location detector. Upon reception of the beacon, the AMP location detector may be configured to synchronize a TSF value of the AMP device (hereinafter referred to as an “AMP TSF value”) with the TSF value of the AP (hereinafter referred to as an “AP TSF value”). The AMP location detector may be configured to generate a target message and transmit the target message to the buddy devices. A time duration between the TSF synchronization at the AMP device and the transmission of the target message may correspond to a target delay of the AMP device. In an example, if the AMP device has harvested enough energy, the target message may be transmitted more than one time to produce multiple samples of the target message at the buddy devices.

The target message may include an AMP timestamp value. In an example, the AMP timestamp value may be configured to indicate a time-of-sending of the target message. The AMP timestamp value may thus be the current value of the TSF timer of the AMP device (e.g., the current AMP TSF value). As the AMP TSF value is synchronized when the beacon is received from the AP, the AMP timestamp value may be a function of the initial synchronized AMP TSF value and the target delay of the AMP device. In some more embodiments, the target message may include the target delay and a synchronization timestamp value indicative of the timing value that the AMP device was synchronized to. The target message may also include an AP indicator configured to indicate the AP with whom the AMP device has synchronized. Examples of the AP indicator may include a Basic Service Set Identifier (“BSSID”) of the AP, channel information of the AP, or the like.

The location detection logic of a buddy device (hereinafter referred to as a “buddy location detector”) may be configured to receive the target message from the AMP location detector. The buddy location detector may be configured to record a time-of-arrival of the target message based on a TSF value of the buddy device (hereinafter referred to as a “buddy TSF value”). In other words, the buddy location detector may be configured to generate a message timestamp value indicating the time-of-arrival of the target message, from the AMP device, at the buddy device. The buddy location detector may be configured to record a Received Signal Strength Indicator (“RSSI”) of the target message. The buddy location detector may be configured to extract the AP indicator from the target message and identify the AP that has synced with the AMP device based on the AP indicator. The identification of the syncing AP may indicate that the message timestamp value may be required to be synchronized with the TSF timer of the AP. Hence, in case the buddy device is not synchronized with the identified AP, the buddy device may be configured to listen to another beacon from the AP.

The AP location detector may be configured to transmit, to the buddy device, another beacon that may be configured to indicate the AP TSF value. The buddy location detector may be configured to receive the beacon from the AP location detector and synchronize the buddy TSF value with the AP TSF value. Based on the synchronized buddy TSF value, the buddy location detector may be configured to update the recorded time-of-arrival of the target message. The updated time-of-arrival (e.g., the updated message timestamp value) and the recorded RSSI of the target message may be configured to facilitate the detection of the location of the AMP device in the wireless network.

In the wireless network, although various TSF timers are synchronized, all the TSF timers may not run at the same speed due to slight differences in their hardware and environmental conditions such as temperature changes. This may be referred to as a clock drift, where the clocks (e.g., the TSF timers) experience gradual deviation or variation from the accurate time over a period. In many further embodiments, the TSF timer of the AMP device may experience a clock drift as compared to the TSF timers of the AP and the buddy device. Thus, the AMP timestamp values (e.g., the target delays) reported by the AMP device in the target message vary for different samples.

The buddy location detector may be configured to determine a clock drift of the AMP device. The variations in the target delays of the multiple samples of the target message may be utilized for determining the clock drift. Based on the determined clock drift, the buddy location detector may be configured to determine a processing delay of the AMP device. In many additional embodiments, the processing delay may correspond to the target delay without the clock drift variations. In other words, the processing delay may correspond to the actual time duration between the TSF synchronization at the AMP device and the transmission of the target message. The processing delay may be configured to facilitate the detection of the location of the AMP device in the wireless network.

The AP location detector may be configured to obtain the AMP TSF value from the AMP device (e.g., the AMP location detector). The AP location detector may be configured to obtain, from the buddy device (e.g., the buddy location detector), the synchronization timestamp value, the updated message timestamp value, and the RSSI of the target message and the processing delay of the AMP device determined at the buddy device. Based on the AMP TSF value, the processing delay, and the AP TSF value, the AP location detector may be configured to determine a TSF error at the AMP device. The AP location detector may be configured to determine a time-of-travel of the target message from the AMP device to the buddy device based on the updated message timestamp value, the synchronization timestamp value, the processing delay, and the TSF error at the AMP device. Based on the time-of-travel of the target message from the AMP device to the buddy device, the AP location detector may be configured to determine a distance between the AMP device and the buddy device. In some cases, the AP location detector may be configured to determine the time-of-travel of the target message from the AMP device to the buddy device, and in turn, the distance between the AMP device and the buddy device further based on the RSSI of the target message.

The AP location detector may be configured to obtain a distance between the AP and the buddy device. Based on the determined distance between the AMP device and the buddy device and the obtained distance between the AP and the buddy device, the AP location detector may be configured to determine a distance between the AP and the AMP device. Once all the three distances are determined and the locations of the buddy device and the AP are known, the location of the AMP device can be detected. Thus, the AP location detector may be configured to detect the location of the AMP device in the wireless network based on the location of the buddy device in the wireless network, the location of the AP in the wireless network, the distance between the AMP device and the buddy device, and the distance between the AP and the AMP device.

A single buddy device assisting in locating the AMP device is described for the sake of brevity. Updated message timestamp values and AMP device processing delays determined by other buddy devices of the wireless network that receive the target message may also be utilized in detecting the location of the AMP device in a similar manner as described above. More the buddy devices that assist in the location detection operation, the higher the precision of the detected location. Further, locations of the other AMP devices in the wireless network may be detected in a similar manner as described above.

The detected locations can be utilized to facilitate various operations at the AMP devices. For example, the detected location of the AMP device may be utilized to determine whether a network device at a particular position has the AMP device in sight. Further, the detected locations can be utilized to determine how to charge the AMP device (e.g., duration and source of the charging frames), to determine how to schedule medium access for the AMP device, to classify the AMP device into a geographical group, to position the AMP device on a floor map, or the like.

Although it is described that an AP detects the location of the AMP devices, the scope of the present disclosure is not limited to it. In still yet additional embodiments, the operations performed by the AP may be performed by a location server associated with the wireless network. In such a scenario, the AMP device and the buddy devices may still perform TSF synchronization based on beacons received from a reference AP.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer-readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (“PCB”) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as a field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board, or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

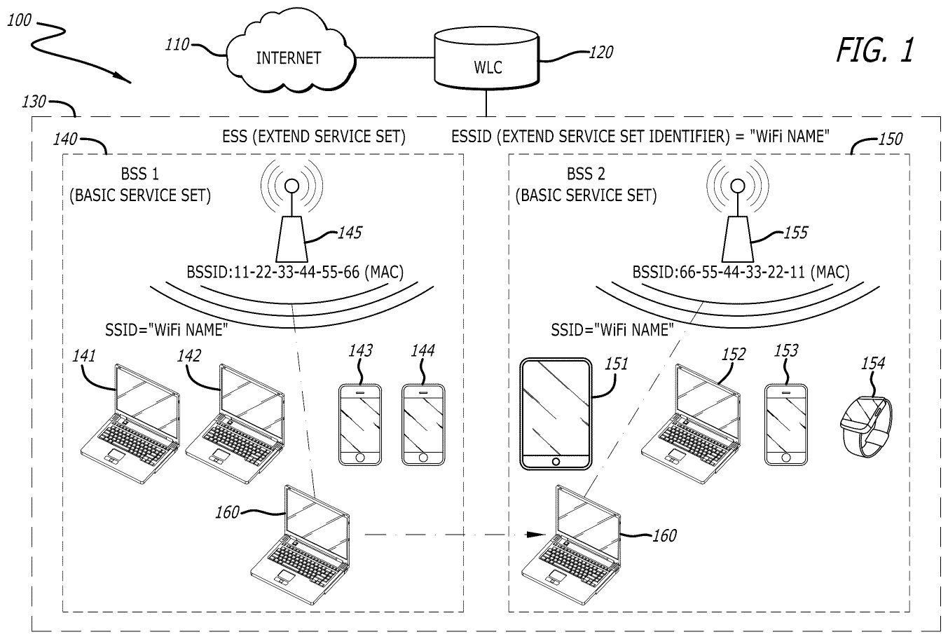

Referring to FIG. 1, a schematic block diagram of a wireless local networking system 100 in accordance with various embodiments of the disclosure is shown. Wireless local networking standards can play an important role in enabling seamless communication and connectivity between various devices within localized areas. One of the most prevalent standards is Wireless Fidelity (“Wi-Fi”), which is based on the Institute of Electrical and Electronics Engineers (“IEEE”) 802.11 family of protocols. Wi-Fi can provide high-speed wireless access to the Internet and local network resources, with iterations such as 802.11a, 802.11b, 802.11g, 802.11n, 802.11ac, and 802.11ax, each offering improvements in speed, range, and efficiency. Each adoption of the Wi-Fi standards can often be designed to bring enhanced performance, increased capacity, and better efficiency in crowded network environments. Other standards can commonly be used for short-range wireless communication between devices, particularly in the realm of personal area networks (“PANs”). Both Wi-Fi and other protocols have become integral components of modern connectivity, supporting a wide range of devices and applications across homes, businesses, and public spaces. Emerging technologies and future iterations continue to refine wireless networking standards, ensuring the evolution of efficient, reliable, and secure wireless communication.

In the realm of IEEE 802.11 wireless local area networking standards, commonly associated with Wi-Fi technology, a service set may be utilized for defining and organizing wireless network devices. A service set can refer to a collection of wireless devices that share a common Service Set Identifier (“SSID”). The SSID, often recognizable to users as the network name presented in natural language, can serve as a means of identification and differentiation among various wireless networks. Within a service set, the nodes (e.g., devices like laptops, smartphones, or other Wi-Fi-enabled devices) can operate collaboratively, adhering to shared link-layer networking parameters. These parameters may encompass specific communication settings and protocols that facilitate seamless interaction among the devices within the service set. Essentially, a service set may form a cohesive and logical network segment, creating an organized structure for wireless communication where devices can communicate and share data within the defined parameters, enhancing the efficiency and coordination of wireless networking operations.

In the context of wireless local area networking standards, a service can be configured in two distinct forms: a Basic Service Set (“BSS”) or an Extended Service Set (“ESS”). A BSS may represent a subset within a service set, comprised of devices that share common physical-layer medium access characteristics. These characteristics can include parameters such as radio frequency, modulation scheme, and security settings, ensuring seamless wireless networking among the devices. The BSS can be uniquely identified by a Basic Service Set Identifier (“BSSID”). In an example, the BSSID may correspond to a 48-bit label adhering to Media Access Control (“MAC”)-48 conventions. Despite the possibility of a device having multiple BSSIDs, each BSSID may typically be associated with, at most, one BSS at any given time.

A BSS should not be confused with the coverage area of an access point (“AP”), which is referred to as the Basic Service Area (“BSA”). The BSA encompasses the physical space within which an AP can provide wireless coverage, while the BSS may focus on the logical grouping of devices sharing common networking characteristics. This distinction emphasizes that the BSS may be a conceptual grouping based on shared communication parameters, while the BSA may define the spatial extent of an AP's wireless reach. Understanding these distinctions may be fundamental for effectively configuring and managing wireless networks, ensuring optimal performance and coordination among connected devices.

The SSID may define a service set or may extend a service set. Normally, the SSID may be broadcast in the clear by stations in beacon packets to announce the presence of a network and seen by users as a wireless network name. Unlike BSSIDs, SSIDs may usually be customizable. Since the contents of an SSID field are arbitrary, the 802.11 standard permits devices to advertise the presence of a wireless network with beacon packets. A station may also likewise transmit packets in which the SSID field is set to null; this prompts an associated AP to send the station a list of supported SSIDs. Once a device is associated with a BSS, for efficiency, the SSID may not be sent within packet headers; only BSSIDs may be used for addressing.

An ESS may be a more sophisticated wireless network architecture designed to provide seamless coverage across a larger area, typically spanning environments such as homes or offices that may be too expansive for reliable coverage by a single AP. This network can be created through the collaboration of multiple APs, presenting itself to users as a unified and continuous network experience. The ESS may operate by integrating one or more infrastructure BSSs within a common logical network segment, characterized by sharing the same Internet Protocol (“IP”) subnet and Virtual Local Area Network (“VLAN”).

The concept of an ESS may be particularly advantageous in scenarios where a single AP cannot adequately cover the entire desired area. By employing multiple APs strategically, users can move seamlessly across the ESS without experiencing disruptions in connectivity. This may maintain a consistent wireless experience in larger spaces, where users may transition between different physical locations covered by distinct APs.

Moreover, ESSs offer additional functionalities, such as distribution services and centralized authentication. The distribution services may facilitate the efficient distribution of network resources and services across the entire ESS. Centralized authentication may enhance security and simplify access control by allowing users to authenticate once for access to any part of the ESS, streamlining the user experience and network management. Overall, ESSs may provide a scalable and robust solution for ensuring reliable and comprehensive wireless connectivity in diverse and expansive environments.

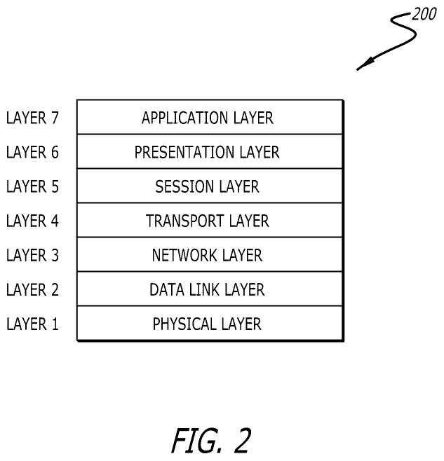

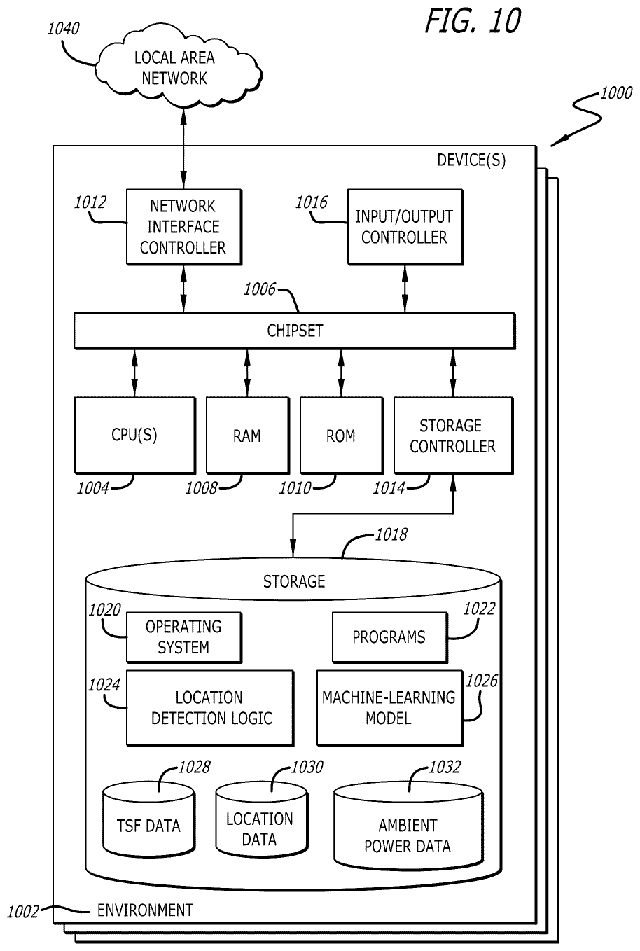

The network can include a variety of end devices that connect to the network. These devices can sometimes be referred to as stations (“STAs”). Each device may typically be configured with a MAC address in accordance with the IEEE 802.11 standard. As described in more detail in FIG. 2, a physical layer can also be configured to communicate over the wireless medium. As described in more detail in FIG. 10, various devices on a network can include components such as a processor, transceiver, user interface, or the like. These components can be configured to process frames of data transmitted and/or received over the wireless network. APs may be wireless devices configured to provide access to end devices to a larger network, such as the Internet 110.

In the embodiment depicted in FIG. 1, a wireless network controller 120 (shown as WLC) may be connected to a public network such as the Internet 110. The wireless network controller 120 may be in communication with an ESS (e.g., an ESS 130). The ESS 130 may include two separate BSSs (e.g., BSS1 140 and BBS2 150). The ESS 130, BSS1 140, and BSS2 150 all broadcast and may be configured with the same SSID (e.g., “Wi-Fi Name”, which can be a BSSID for each of the BSS1 140 and BSS2 150 as well as an ESSID for the ESS 130).

Within the BSS1 140, the network may include a first notebook 141, a second notebook 142, a first phone 143, a second phone 144, and a third notebook 160. Each of these devices can communicate with a first AP 145. Likewise, in the BSS2 150, the network may include a first tablet 151, a fourth notebook 152, a third phone 153, and a first watch 154. The third notebook 160 may be communicatively connected to both the BSS1 140 and BSS2 150. In this setup, the third notebook 160 can be seen to “roam” from the physical area serviced by the BSS1 140 and into the physical area serviced by the BSS2 150.

Although a specific embodiment for the wireless local networking system 100 is described above with respect to FIG. 1, any of a variety of systems and/or processes may be utilized in accordance with embodiments of the disclosure. For example, the wireless local networking system 100 may be configured into any number of various network topologies including different types of interconnected devices and user devices. The elements depicted in FIG. 1 may also be interchangeable with other elements of FIGS. 2-10 as required to realize a particularly desired embodiment.

Referring to FIG. 2, a conceptual depiction of a communication layer architecture 200 in accordance with various embodiments of the disclosure is shown. In many embodiments, the communication layer architecture 200 can be utilized to carry out various communications described or required herein. In still more embodiments, the communication layer architecture 200 can be configured as the open systems interconnection model, more commonly known as the OSI model. Likewise, the communication layer architecture 200 may have seven layers which may be implemented in accordance with the OSI model.

In the embodiment depicted in FIG. 2, the communication layer architecture 200 may include a first physical layer, which can serve as the foundational layer among the seven layers. It may be responsible for the transmission and reception of raw, unstructured data bits over a physical medium, such as cables or wireless connections. At this layer, the focus may be on the electrical, mechanical, and procedural characteristics of the hardware, including cables, connectors, and signaling. The primary goal may be to establish a reliable and efficient means of physically transmitting data between devices. The physical layer may not concern itself with the meaning or interpretation of the data; instead, may concentrate on the fundamental aspects of transmitting binary information, addressing issues like voltage levels, data rates, and modulation techniques. Devices operating at the physical layer may include network cables, connectors, repeaters, and hubs. The successful operation of the physical layer may be fundamental to the functioning of the entire OSI model, as it forms the bedrock upon which higher layers build their more complex communication protocols and structures.

In some embodiments, the communication layer architecture 200 can include a second data link layer which may be configured to be primarily concerned with the reliable and efficient transmission of data between directly connected devices over a particular physical medium. The responsibilities may include framing data into frames, addressing, error detection, and, in some cases, error correction. The data link layer may be divided into two sublayers: Logical Link Control (LLC) and MAC. The LLC sublayer may manage flow control and error checking, while the MAC sublayer may be responsible for addressing devices on the network and controlling access to the physical medium. Ethernet may be a common example of a data link layer protocol. This layer may ensure that data is transmitted without errors and may manage the flow of frames between devices on the same local network. Bridges and switches can operate at the data link layer, making forwarding decisions based on MAC addresses. Overall, the data link layer may assist in creating a reliable point-to-point or point-to-multipoint link for data transmission between neighboring network devices.

In various embodiments, the communication layer architecture 200 can include a third network layer which can be configured as a component responsible for the establishment of end-to-end communication across interconnected networks. Its primary functions may include logical addressing, routing, and the fragmentation and reassembly of data packets. The network layer can ensure that data is efficiently directed from the source to the destination, even when the devices are not directly connected. IP may be an example of a network layer protocol. Devices known as routers can operate at this layer, making decisions on the optimal path for data to traverse through a network based on logical addressing. The network layer can abstract the underlying physical and data link layers, allowing for a more scalable and flexible communication infrastructure. In essence, it can provide the necessary mechanisms for devices in different network segments to communicate, contributing to the end-to-end connectivity that enables the functioning of the Internet and other large-scale networks.

In additional embodiments, the fourth transport layer can be an element responsible for the end-to-end communication and reliable delivery of data between devices. Its primary objectives may include error detection and correction, flow control, and segmentation and reassembly of data. Two key transport layer protocols may be Transmission Control Protocol (“TCP”) and User Datagram Protocol (“UDP”). TCP may ensure reliable and connection-oriented communication by establishing and maintaining a connection between sender and receiver, and orderly and error-free delivery of data through mechanisms like acknowledgment and retransmission. UDP, on the other hand, can offer a connectionless and more lightweight approach suitable for applications where speed and real-time communication take precedence over reliability. The transport layer may shield the upper-layer protocols from the complexities of the network and data link layers, providing a standardized interface for applications to send and receive data, making it a facilitator for efficient, end-to-end communication in networked environments.

In further embodiments, a fifth session layer can be configured to play a role in managing and controlling communication sessions between applications. It may provide mechanisms for establishing, maintaining, and terminating dialogues or connections between devices. The session layer can help synchronize data exchange, ensuring that information is sent and received in an orderly fashion. Additionally, it may support functions such as checkpointing, which allows for the recovery of data in the event of a connection failure, and dialog control, which manages the flow of information between applications. While the session layer is not as explicitly implemented as lower layers, its services play a role in maintaining the integrity and coherence of data during interactions between applications. By managing the flow of data and establishing the context for communication sessions, the session layer can contribute to the overall reliability and efficiency of data exchange in networked environments.

In still more embodiments, the communication layer architecture 200 can include a sixth presentation layer, which may focus on the representation and translation of data between the application layer and the lower layers of the network stack. It can deal with issues related to data format conversion, ensuring that information is presented in a standardized and understandable manner for both the sender and the receiver. The presentation layer can often be responsible for tasks such as data encryption and compression, which enhance the security and efficiency of data transmission. By handling the transformation of data formats and character sets, the presentation layer can facilitate seamless communication between applications running on different systems. This layer may then abstract the complexities of data representation, enabling applications to exchange information without worrying about differences in data formats. In essence, the presentation layer can play a role in ensuring interoperability and data integrity between diverse systems and applications within a networked environment.

Finally, the communication layer architecture 200 can also comprise a seventh application layer which may serve as the interface between the network and the software applications that end-users interact with. It can provide a platform-independent environment for communication between diverse applications and ensure that data exchange is meaningful and understandable. The application layer can encompass a variety of protocols and services that support functions such as file transfers, electronic mail, remote login, and web browsing. It can act as a mediator, allowing different software applications to communicate seamlessly across a network. Some well-known application layer protocols can include Hypertext Transfer Protocol (“HTTP”), File Transfer Protocol (“FTP”), and Simple Mail Transfer Protocol (“SMTP”). In essence, the application layer can enable the development of network-aware applications by defining standard communication protocols and offering a set of services that facilitate robust and efficient end-to-end communication across networks.

Although a specific embodiment for a communication layer architecture 200 is described above with respect to FIG. 2, any of a variety of systems and/or processes may be utilized in accordance with the embodiments of the disclosure. For example, various aspects described herein may reside or be carried out on one layer or a plurality of layers. The elements depicted in FIG. 2 may also be interchangeable with other elements of FIG. 1 and FIGS. 3-10 as required to realize a particularly desired embodiment.

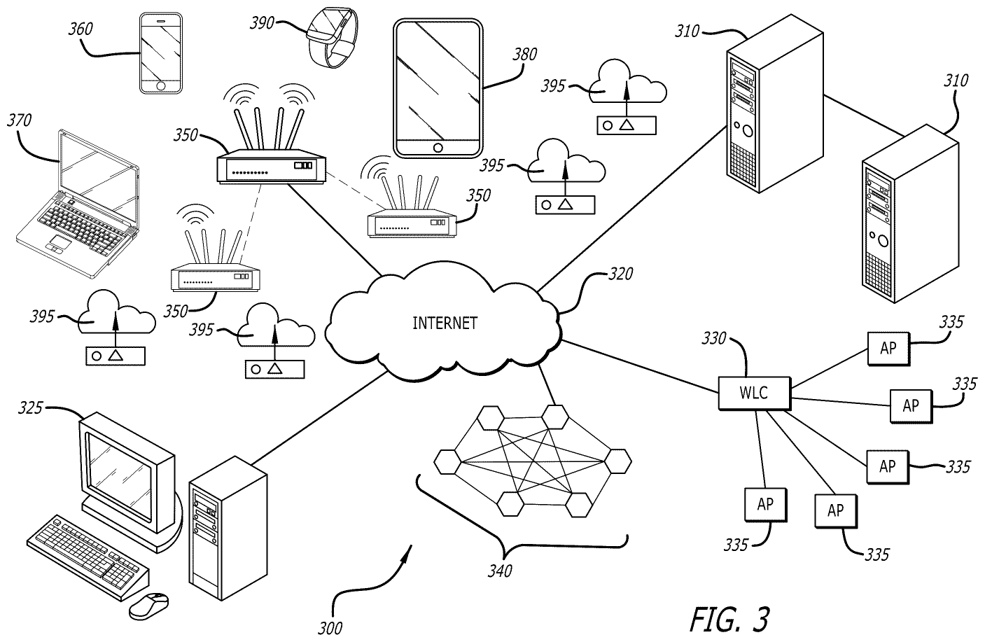

Referring to FIG. 3, a conceptual network diagram 300 of various environments that a location detection logic may operate within in accordance with various embodiments of the disclosure is shown. The location detection logic can include various hardware and/or software deployments and can be configured in a variety of ways. In many embodiments, the location detection logic can be configured as a standalone device, exist as a logic within another network device, be distributed among various network devices operating in tandem, or remotely operated as part of a cloud-based network management tool.

In a number of embodiments, one or more servers 310 can be configured with the location detection logic or can otherwise operate as the location detection logic. In a variety of embodiments, the location detection logic may operate on the one or more servers 310 connected to a communication network 320 (shown as the “Internet”). The communication network 320 can include wired networks or wireless networks. The location detection logic can be provided as a cloud-based service that can service remote networks, such as, but not limited to a deployed network 340.

However, in more embodiments, the location detection logic may be operated as a distributed logic across multiple network devices. In the embodiment depicted in FIG. 3, a plurality of APs 350 can operate as the location detection logic in a distributed manner or may have one specific device operate as the location detection logic for all of the neighboring or sibling APs 350. The APs 350 may facilitate Wi-Fi connections for various electronic devices, such as but not limited to, mobile computing devices including laptop computers 370, cellular phones 360, portable tablet computers 380, and wearable computing devices 390.

In additional embodiments, the location detection logic may be integrated within another network device. In the embodiment depicted in FIG. 3, a wireless LAN controller (“WLC”) 330 may have an integrated location detection logic that the WLC 330 can use to detect locations of the APs 335 that the WLC 330 is connected to, either wired or wirelessly. In further embodiments, a personal computer 325 may be utilized to access and/or manage various aspects of the location detection logic, either remotely or within the network itself. In the embodiment depicted in FIG. 3, the personal computer 325 can communicate over the communication network 320 and can access the location detection logic of the servers 310, the APs 350, or the WLC 330.

With advancements in the field of energy harvesting and sustainability, the wireless networks have seen a rise in ambient power (“AMP”) devices. AMP may refer to the practice of harnessing energy from the surrounding environment to power devices, often with minimal or no reliance on traditional batteries or wired electricity. This technology has become viable due to, for example, advancements in materials science, electronics, and energy conversion methods. As illustrated in FIG. 3, the network diagram 300 may include AMP devices 395. Examples of the AMP devices 395 may include, but are not limited to, solar-powered Wi-Fi access points, thermal energy harvesting sensors, Radio Frequency (“RF”) energy harvesting devices, piezoelectric energy harvesting units, ambient light-powered indoor sensors, and small-scale wind energy harvesting devices. The AMP devices 395 can leverage various ambient energy sources, such as sunlight, thermal gradients, RF signals, mechanical vibrations, indoor lighting, wind, or the like, to power their operations. In some implementations, the AMP devices 395 may also be used as an AP.

Although a specific embodiment for various environments that a location detection logic may operate within suitable for carrying out the various steps, processes, methods, and operations described herein is discussed with respect to FIG. 3, any of a variety of systems and/or processes may be utilized in accordance with embodiments of the disclosure. In many non-limiting examples, the location detection logic may be provided as a device or software separate from the WLC 330 or the location detection logic may be integrated into the WLC 330. The elements depicted in FIG. 3 may also be interchangeable with other elements of FIGS. 1, 2, and 4-10 as required to realize a particularly desired embodiment.

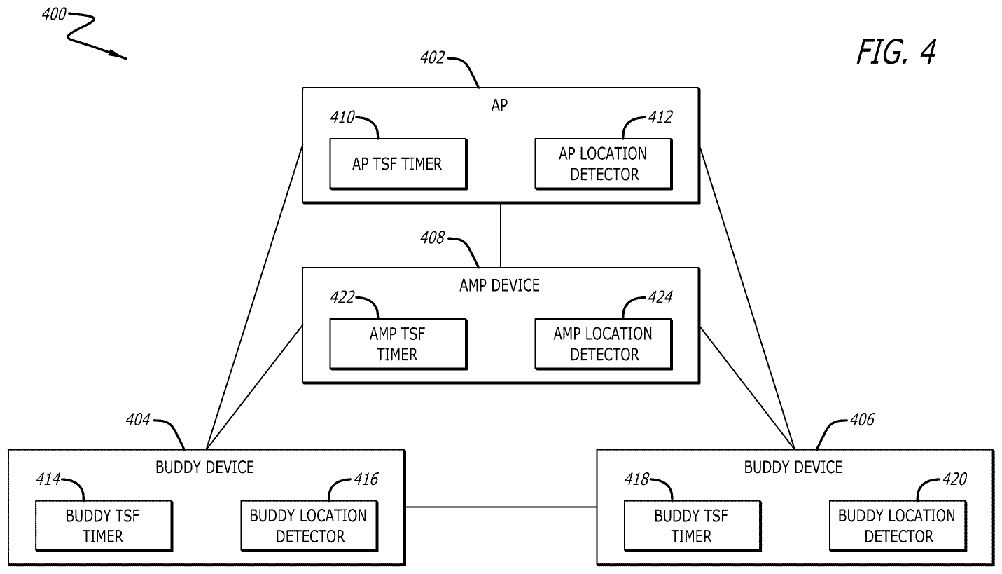

Referring to FIG. 4, a networking environment 400 for location detection of AMP devices in accordance with various embodiments of the disclosure is shown. In a variety of embodiments, the networking environment 400 may correspond to a wireless network. The networking environment 400 may include an AP 402, one or more buddy devices, for example, buddy devices 404 and 406, and an AMP device 408. Each of the AP 402, the buddy devices 404 and 406, and the AMP device 408 may include a timing synchronization function (“TSF”) timer and a location detector. For example, the AP 402 may include an AP TSF timer 410 and an AP location detector 412. Similarly, the buddy device 404 may include a buddy TSF timer 414 and a buddy location detector 416, and the buddy device 406 may include a buddy TSF timer 418 and a buddy location detector 420. The AMP device 408 may include an AMP TSF timer 422 and an AMP location detector 424.

The AP 402 may be a network device that allows wireless devices to connect to a wired network using Wi-Fi or related standards. The AP 402 may act as a bridge, enabling seamless communication between various wireless devices and providing extended coverage and network capacity. Examples of the wireless devices may include various electronic devices, such as but not limited to, mobile computing devices including laptop computers, cellular phones, portable tablet computers, and wearable computing devices.

A buddy device, such as the buddy devices 404 and 406, may correspond to other network devices (e.g., apart from the AP 402) of the networking environment 400. The buddy devices 404 and 406 may include other APs, wireless stations, or the like. In the present disclosure, the buddy devices 404 and 406 may assist in the location detection of an AMP device (e.g., the AMP device 408).

The AMP device 408 may be configured to harness energy from the surrounding environment. Examples of the AMP device 408 may include, but are not limited to, solar-powered Wi-Fi access points, thermal energy harvesting sensors, RF energy harvesting devices, piezoelectric energy harvesting units, ambient light-powered indoor sensors, and small-scale wind energy harvesting devices. The AMP device 408 can leverage various ambient energy sources, such as sunlight, thermal gradients, RF signals, mechanical vibrations, indoor lighting, wind, or the like, to power their operations.

The AMP device 408 can thus play a transformative role in the wireless networks by providing a sustainable and maintenance-free energy source for a multitude of wireless sensors and devices. In the wireless networks, especially in the context of the Internet of Things (“IoT”), the deployment of numerous sensors and devices can enable gathering data, monitoring conditions, and enabling communication. Traditionally, these devices rely on batteries, which may require regular replacement or recharging, posing logistical challenges and increasing operational costs. The AMP device 408, however, can harvest energy from the environment thus reducing or even eliminating the need for battery replacements. This can not only enhance the reliability and lifespan of the wireless networks but can also make them more cost-effective and environmentally friendly. Moreover, the integration of the AMP device 408 into the wireless networks can enhance the scalability and resilience of the wireless networks. For example, these devices can operate autonomously in remote or hard-to-reach locations, where regular maintenance can be difficult.

Given the role the AMP device 408 plays in the wireless networks, it may be important to accurately locate the AMP device 408 in the wireless networks for optimizing their performance and efficiency. The effectiveness of the AMP device 408 may depend significantly on its exposure to environmental energy sources, such as sunlight, vibrations, or RF signals. Additionally, the accurate location of the AMP device 408 enhances the overall network performance and data accuracy. Conventionally, the wireless network space is swept with radio beams to detect AMP devices and their locations. However, such an approach may not yield accurate results and may impact the efficiency and performance of the network operations.

To solve the aforementioned issue, in the present disclosure, a location detection operation is described that uses TSF-based timestamping and relay by other network devices (e.g., the buddy devices 406 and 408) of the wireless network to detect the location of an AMP device (e.g., the AMP device 408). In the present disclosure, the locations of the buddy 406 and 408 devices are known, and hence, can be utilized for assisting the AMP device location detection operation. The TSF time-stamping process is simpler, consumes less airtime, and has lower frame processing complexity than conventional ranging protocols.

In the present disclosure, the AP 402 supporting a plurality of devices including the AMP device 408, may detect a location of the AMP device 408 in the wireless network using the buddy devices 404 and 406 of the wireless network. The buddy devices 404 and 406 may thus act as relays for the AMP device energy harvesting and frame detection. In the present disclosure, the detection of the location of the AMP device 408 using one buddy device (e.g., the buddy device 404) is explained in detail to keep the description concise and clear. This should not be considered a limitation of the present disclosure. The buddy device 406 may be utilized for detecting the location of the AMP device 408 in a similar manner.

A location detector (e.g., the AP location detector 412, the buddy location detectors 416 and 420, and the AMP location detector 424) may include suitable circuitry that may be configured to perform one or more operations. For example, the AP location detector 412, the buddy location detectors 416 and 420, and the AMP location detector 424 may be configured to perform various operations associated with the location detection of the AMP device 408.

In many embodiments, the AP location detector 412 may be configured to transmit a beacon to the AMP device 408. The beacon may be configured to indicate a TSF value of the AP 402. In an example, the TSF value of the AP 402 may correspond to a value of the AP TSF timer 410. A TSF timer (e.g., the AP TSF timer 410, the buddy TSF timers 414 and 418, and the AMP TSF timer 422) may be utilized to ensure that all devices within a wireless network are synchronized by maintaining a consistent time reference for coordinating communication, managing power-saving modes, and optimizing network performance. This synchronization can help in minimizing collisions and enhancing the overall efficiency of the wireless network.

The AMP location detector 424 may be configured to receive the beacon transmitted by the AP location detector 412. Upon reception of the beacon, the AMP location detector 424 may be configured to synchronize a TSF value of the AMP device 408 with the TSF value of the AP (hereinafter referred to as an “AP TSF value”). In an example, the TSF value of the AMP device 408 may correspond to a value of the AMP TSF timer 422. Hereinafter, the TSF value of the AMP device 408 is referred to as an “AMP TSF value”.

The AMP location detector 424 may be configured to generate a target message and transmit the target message to the buddy devices (e.g., the buddy devices 404 and 406). The AMP TSF value may thus be synchronized with the AP TSF value prior to the transmission of the target message. A time duration between the TSF synchronization at the AMP device 408 and the transmission of the target message may correspond to a target delay of the AMP device 408. In an example, if the AMP device 408 has harvested enough energy, the target message may be transmitted more than one time to produce multiple samples of the target message at the buddy devices.

The target message may include an AMP timestamp value. In an example, the AMP timestamp value may be configured to indicate a time-of-sending of the target message. The AMP timestamp value may thus be the current value of the AMP TSF timer 422 (e.g., the current AMP TSF value). As the AMP TSF value is synchronized when the beacon is received from the AP 402, the AMP timestamp value may be a function of the initial synchronized AMP TSF value and the target delay of the AMP device 408. In some more embodiments, the target message may include the target delay and a synchronization timestamp value indicative of the timing value that the AMP device 408 was synchronized to. The target message may also include an AP indicator configured to indicate the AP 402 with whom the AMP device 408 has synchronized. Examples of the AP indicator may include a BSSID of the AP 402, channel information of the AP 402, or the like.

In yet more embodiments, the target message may include one or more frames configured to indicate at least one timing attribute (e.g., the AMP timestamp value, the target delay, the AP TSF value, the AP indicator, or the like) of the AMP device 408. In still yet more embodiments, the target message may correspond to a probe request configured to indicate the at least one timing attribute of the AMP device 408. In such a scenario, the probe request may include one or more information elements (“IEs”) to indicate the at least one timing attribute of the AMP device 408.

The buddy location detector 416 of the buddy device 404 may be configured to receive the target message from the AMP location detector 424. The buddy location detector 416 may be configured to record a time-of-arrival of the target message based on a TSF value of the buddy device 404. In an example, the TSF value of the buddy device 404 may correspond to a value of the buddy TSF timer 414. Hereinafter, the TSF value of the buddy device 404 is referred to as a “buddy TSF value”. In other words, the buddy location detector 416 may be configured to generate a message timestamp value indicating the time-of-arrival of the target message, from the AMP device 408, at the buddy device 404. In an example, the message timestamp value may have sub-nanosecond precision. The buddy location detector 416 may be configured to record a Received Signal Strength Indicator (“RSSI”) of the target message. The buddy location detector 416 may be configured to extract the AP indicator from the target message and identify the AP 402 that has synced with the AMP device 408 based on the AP indicator. The identification of the syncing AP 402 may indicate that the message timestamp value may be required to be synchronized with the AP TSF timer 410. Hence, the buddy device 404 may be configured to listen to another beacon from the AP 402.

The AP location detector 412 may be configured to transmit, to the buddy device 404, another beacon that may be configured to indicate the AP TSF value. The buddy location detector 416 may be configured to receive the beacon from the AP location detector 412 and synchronize the buddy TSF value with the AP TSF value. Thus, based on the AP indicator (e.g., the BSSID, the channel information, or the like, of the AP 402), the AP TSF value may be utilized for the synchronization of the buddy TSF value. Based on the synchronized buddy TSF value, the buddy location detector 416 may be configured to update the recorded time-of-arrival of the target message. The updated time-of-arrival (e.g., the updated message timestamp value) and the recorded RSSI of the target message may be configured to facilitate the detection of the location of the AMP device 408 in the wireless network.

In the wireless network, although various TSF timers are synchronized, all the TSF timers may not run at the same speed due to slight differences in their hardware and environmental conditions such as temperature changes. This may be referred to as a clock drift, where the clocks (e.g., the TSF timers) experience gradual deviation or variation from the accurate time over a period. In many further embodiments, the AMP TSF timer 422 may experience a clock drift as compared to the AP TSF timer 410 and the buddy TSF timer 414. Thus, the AMP timestamp values (e.g., the target delays) reported by the AMP device 408 in the target message vary for different samples.

The buddy location detector 416 may be configured to determine a clock drift of the AMP device 408. The variations in the target delays of the multiple samples of the target message may be utilized for determining the clock drift. For example, at the buddy device 404, the buddy location detector 416 may determine the time-of-travel of the target message to be equal to a difference between the recorded time-of-arrival and the AMP timestamp value of the target message. Between the two samples, the distance between the AMP device 408 and the buddy device 404 may not change. Hence, the time-of-travel may remain the same between the two samples. From each sample of the target message, the buddy location detector 416 may be configured to extract the synchronization timestamp value and the target delay of the corresponding sample. Based on the time-of-travel remaining the same between samples and the extracted synchronization timestamp values and target delays of each sample, the buddy location detector 416 may be configured to determine (e.g., predict) the clock drift of the AMP device 408.

Based on the determined clock drift, the buddy location detector 416 may be configured to determine a processing delay of the AMP device 408. In many additional embodiments, the processing delay may correspond to the target delay without the clock drift variations. In other words, the processing delay may correspond to the actual time duration between the TSF synchronization at the AMP device 408 and the transmission of the target message by the AMP device 408. The processing delay may be configured to facilitate the detection of the location of the AMP device 408 in the wireless network.

The AP location detector 412 may be configured to obtain the AMP TSF value from the AMP device 408 (e.g., the AMP location detector 424). In an example, the AMP TSF value may be obtained via a probe request or another target message. The AP location detector 412 may be configured to obtain, from the buddy device 404 (e.g., the buddy location detector 416), the synchronization timestamp value, the updated message timestamp value, and the RSSI of the target message and the processing delay of the AMP device 408 determined at the buddy device 404. In an example, the synchronization timestamp value, the updated message timestamp value, and the RSSI of the target message, and the processing delay of the AMP device 408 may be obtained via an action frame.

Based on the AMP TSF value, the processing delay, and the AP TSF value, the AP location detector 412 may be configured to determine a TSF error at the AMP device 408. In an example, during the TSF synchronization, the initial beacon may be transmitted by the AP location detector 412 at time “t” and the AMP location detector 424 may receive the beacon at a time “t+dt”, “dt” being the time taken by the beacon to travel from the AP 402 to the AMP device 408. However, as the beacon is indicative of the time “t”, the AMP TSF value may be synchronized at the time “t” resulting in a “dt” error between the AMP TSF value and the AP TSF value. The “dt” error can be referred to as the TSF error at the AMP device 408.

In an example, the AP TSF value is “X” when the first beacon is transmitted to the AMP device 408. The TSF error at the AMP device 408 is “Y” and the processing delay is “Z”. Thus, the updated message timestamp value of the target message may be “X+Y+Z+F”, where “F” is the time-of-travel between the AMP device 408 and the buddy device 404. The updated message timestamp value may thus be a function of the target message synchronization timestamp value, the TSF error at the AMP device 408, the processing delay of the AMP device 408, and a time-of-travel between the AMP device 408 and the buddy device 404. “X” can be obtained from the synchronization timestamp value of the target message, “Y” is determined by the AP location detector 412, and “Z” is obtained from the buddy device 404. Thus, the AP location detector 412 may be configured to determine a time-of-travel of the target message from the AMP device 408 to the buddy device 404 based on the updated message timestamp value, the synchronization timestamp value, the processing delay, and the TSF error at the AMP device 408.

Based on the time-of-travel of the target message from the AMP device 408 to the buddy device 404, the AP location detector 412 may be configured to determine a distance between the AMP device 408 and the buddy device 404. Thus, the distance between the AMP device 408 and the buddy device 404 may be determined based on the updated message timestamp value, the synchronization timestamp value, the processing delay, and the TSF error at the AMP device 408. In some cases, the AP location detector 412 may be configured to determine the time-of-travel of the target message from the AMP device 408 to the buddy device 404, and in turn, the distance between the AMP device 408 and the buddy device 404 further based on the RSSI of the target message.

The AP location detector 412 may be configured to obtain a distance between the AP 402 and the buddy device 404. In still yet further embodiments, the network environment 400 may include a database that may be configured to store the locations of the buddy devices 404 and 406 and the AP 402. The AP location detector 412 may be configured to access the database to obtain the distance between the AP 402 and the buddy device 404. Based on the determined distance between the AMP device 408 and the buddy device 404 and the obtained distance between the AP 402 and the buddy device 404, the AP location detector 412 may be configured to determine a distance between the AP 402 and the AMP device 408.

Once all the three distances are determined and the locations of the buddy device 404 and the AP 402 are known, the location of the AMP device 408 can be detected. Thus, the AP location detector 412 may be configured to detect the location of the AMP device 408 in the wireless network based on the location of the buddy device 404 in the wireless network, the location of the AP 402 in the wireless network, the distance between the AMP device 408 and the buddy device 404, and the distance between the AP 402 and the AMP device 408.

A single buddy device 404 assisting in locating the AMP device 408 is described for the sake of brevity. Updated message timestamp values and AMP device processing delays determined by other buddy devices (e.g., the buddy device 406) of the wireless network that receive the target message may also be utilized in detecting the location of the AMP device 408 in a similar manner as described above. More the buddy devices that assist in the location detection operation, the higher the precision of the detected location. Further, locations of the other AMP devices in the wireless network may be detected in a similar manner as described above.

The detected locations can be utilized to facilitate various operations at the AMP devices. For example, the detected location of the AMP device 408 may be utilized to determine whether a network device at a particular position has the AMP device 408 in sight. Further, the detected location can be utilized to determine how to charge the AMP device 408 (e.g., duration and source of the charging frames), to determine how to schedule medium access for the AMP device 408, to classify the AMP device 408 into a geographical group, to position the AMP device 408 on a floor map, or the like.

In FIG. 4, it is described that the AMP device 408 synchronizes with the first AP (e.g., the AP 402) it can receive a beacon from. However, the scope of the present disclosure is not limited to it. In several embodiments, the AMP device 408 may receive beacons or probe requests from various APs and may select one of the APs for the TSF synchronization. In such scenarios, the target message may include the AP indicator of the selected AP.

Although a specific embodiment for a networking environment for location detection of AMP devices suitable for carrying out the various steps, processes, methods, and operations described herein is discussed with respect to FIG. 4, any of a variety of systems and/or processes may be utilized in accordance with embodiments of the disclosure. For example, the operations performed by an AP may be performed by a location server associated with the wireless network. In such a scenario, the AMP and buddy devices may still perform TSF synchronization based on beacons received from a reference AP. The elements depicted in FIG. 4 may also be interchangeable with other elements of FIGS. 1-3 and 5-10 as required to realize a particularly desired embodiment.

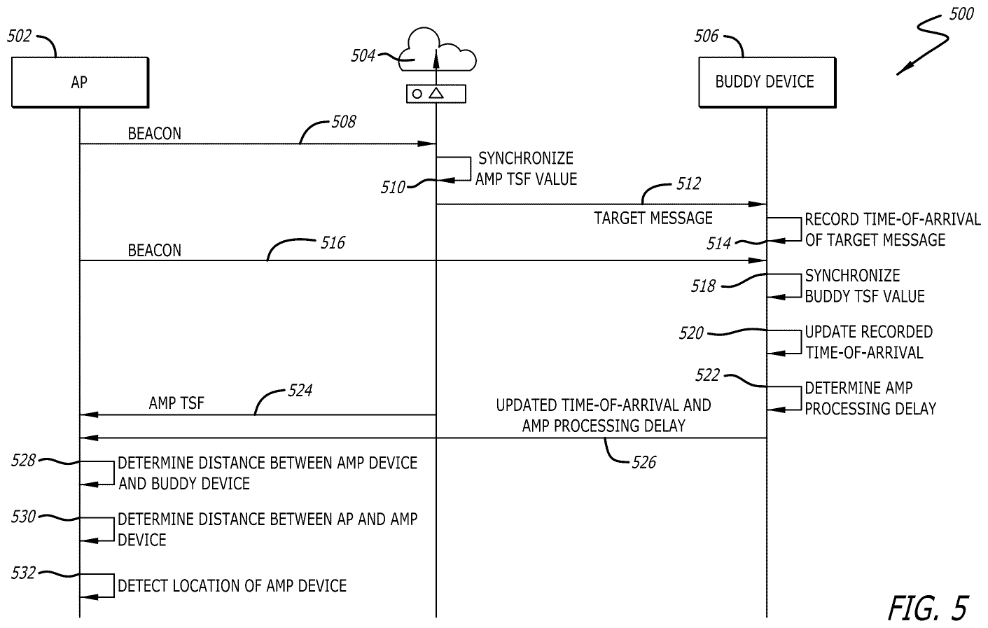

Referring to FIG. 5, a conceptional sequence diagram 500 that illustrates an AMP device location detection operation in accordance with various embodiments of the disclosure is shown. The conceptional sequence diagram 500 may illustrate a sequence of operations executed by an AP 502, an AMP device 504, and a buddy device 506 to facilitate the detection of the location of the AMP device 504 in a wireless network. In many embodiments, the AP 502 (e.g., a location detection logic of the AP 502) may be configured to transmit a beacon to the AMP device 504 (as shown by arrow 508). The beacon may be configured to indicate a TSF value of the AP 502 (hereinafter referred to as “AP TSF value”). A TSF value may correspond to a value of a TSF timer.

In a number of embodiments, the AMP device 504 (e.g., the location detection logic of the AMP device 504) may be configured to synchronize an AMP TSF value (as shown by arrow 510). The AMP TSF value may correspond to a TSF value of the AMP device 504. The AMP TSF value may be synchronized with the AP TSF value.

In a variety of embodiments, the AMP device 504 may be configured to transmit a target message to the buddy device 506 (as shown by arrow 512). A time duration between the TSF synchronization at the AMP device 504 and the transmission of the target message may correspond to a target delay of the AMP device 504. The target message may include an AMP timestamp value. In an example, the AMP timestamp value may be configured to indicate a time-of-sending of the target message. The AMP timestamp value may thus be the current value of the TSF timer of the AMP device 504 (e.g., the current AMP TSF value). As the AMP TSF value is synchronized when the beacon is received from the AP, the AMP timestamp value may be a function of the initial synchronized AMP TSF value and the target delay of the AMP device. In some more embodiments, the target message may include the target delay and a synchronization timestamp value indicative of the timing value that the AMP device 504 was synchronized to. The target message may also include an AP indicator configured to indicate the AP 502 with whom the AMP device 504 has synchronized.

In more embodiments, the buddy device 506 (e.g., a location detection logic of the buddy device 506) may be configured to record a time-of-arrival of the target message (as shown by arrow 514). In other words, the buddy device 506 may be configured to generate a message timestamp value indicating the time-of-arrival of the target message, from the AMP device 504, at the buddy device 506. The time-of-arrival may be recorded based on a TSF value of the buddy device 506 (hereinafter referred to as a “buddy TSF value”).

In additional embodiments, the AP 502 may be configured to transmit another beacon to the buddy device 506 (as shown by arrow 516). The buddy device 506 may be listening to the beacon from the AP 502 after identifying that the AMP device 504 has synced with the AP 502. The AP 502 may be identified based on the AP indicator included in the target message. The beacon may be configured to indicate the AP TSF value.

In further embodiments, the buddy device 506 may be configured to synchronize the buddy TSF value (as shown by arrow 518). The buddy TSF value may be synchronized with the AP TSF value. Thus, based on the AP indicator, the AP TSF value may be utilized for the synchronization of the buddy TSF value.

In still more embodiments, the buddy device 506 may be configured to update the recorded time-of-arrival (as shown by arrow 520). The recorded time-of-arrival of the target message may be updated based on the synchronized buddy TSF value. The updated time-of-arrival (e.g., the updated message timestamp value) of the target message may be configured to facilitate the detection of the location of the AMP device 504 in the wireless network.

In still further embodiments, the buddy device 506 may be configured to determine an AMP processing delay (as shown by arrow 522). The AMP processing delay may be configured to indicate a processing delay of the AMP device 504. The processing delay may correspond to the actual time duration between the TSF synchronization at the AMP device 504 and the transmission of the target message. The processing delay may be configured to facilitate the detection of the location of the AMP device 504 in the wireless network.

In still additional embodiments, the AP 502 may be configured to obtain the AMP TSF value from the AMP device 504 (as shown by arrow 524). In an example, the AMP TSF value may be obtained via a probe request. In another example, the AMP TSF value may be obtained via another target message.

In some more embodiments, the AP 502 may be configured to obtain, from the buddy device 506, the updated time-of-arrival and the AMP processing delay (as shown by arrow 526). In an example, the updated time-of-arrival and the AMP processing delay may be obtained via an action frame. In another example, the updated time-of-arrival and the AMP processing delay may be obtained via a probe request.

In yet more embodiments, the AP 502 may be configured to determine a distance between the AMP device 504 and the buddy device 506 (as shown by arrow 528). The distance between the AMP device 504 and the buddy device 506 may be determined based on the updated time-of-arrival of the target message and the AMP processing delay. In still yet more embodiments, based on the AMP TSF value, the AMP processing delay, and the AP TSF value, a TSF error at the AMP device 504 may be determined. Thus, the distance between the AMP device 504 and the buddy device 506 may be determined further based on the TSF error at the AMP device 504.

In many further embodiments, the AP 502 may be configured to determine a distance between the AP 502 and the AMP device 504 (as shown by arrow 530). In many additional embodiments, the distance between the AP 502 and the AMP device 504 may be determined based on a distance between the AP 502 and the buddy device 506 and the distance between the AMP device 504 and the buddy device 506. The distance between the AP 502 and the AMP device 504 may be obtained from a database that may store the locations of all buddy devices and APs of the wireless network.

In still yet further embodiments, the AP 502 may be configured to detect the location of the AMP device 504. The location of the AMP device 504 may be detected in the wireless network based on the location of the buddy device 506 in the wireless network, the location of the AP 502 in the wireless network, the distance between the AMP device 504 and the buddy device 506, and the distance between the AP 502 and the AMP device 504. The detected location can then be utilized to facilitate various operations at the AMP device 504. For example, the detected location of the AMP device 504 may be utilized to determine whether a network device at a particular position has the AMP device 504 in sight. Further, the detected location can be utilized to determine how to charge the AMP device 504 (e.g., duration and source of the charging frames), to determine how to schedule medium access for the AMP device 504, to classify the AMP device 504 into a geographical group, to position the AMP device 504 on a floor map, or the like.

Although a specific embodiment for a conceptional sequence diagram that illustrates an AMP device location detection operation suitable for carrying out the various steps, processes, methods, and operations described herein is discussed with respect to FIG. 5, any of a variety of systems and/or processes may be utilized in accordance with embodiments of the disclosure. For example, if the buddy device 506 is already synchronized with the AP 502 when the target message is received, the recorded time-of-arrival may be transmitted to the AP 502 with no synchronization being performed at the buddy device 506. The elements depicted in FIG. 5 may also be interchangeable with other elements of FIGS. 1-4 and FIGS. 6-10 as required to realize a particularly desired embodiment.

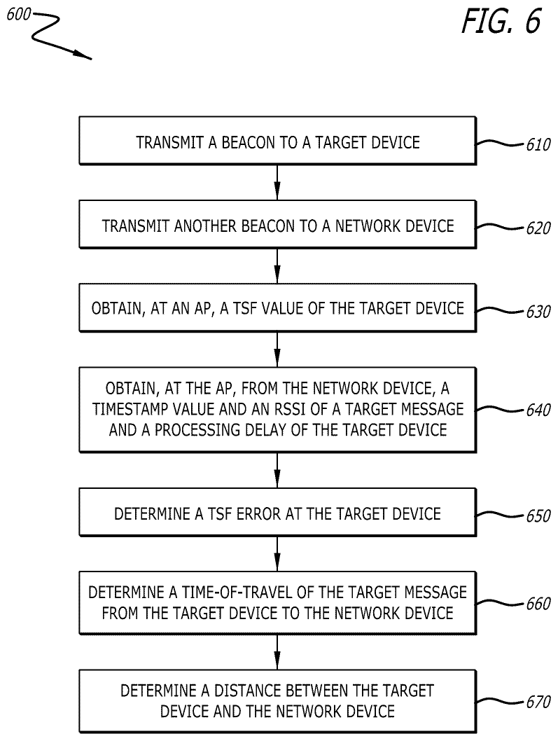

Referring to FIG. 6, a process 600 for determining a distance between a target device and a network device in accordance with various embodiments of the disclosure is shown. In many embodiments, the process 600 may transmit a beacon to a target device (block 610). The target device may correspond to an AMP device. The beacon may be configured to indicate a TSF value of an AP. The TSF value may correspond to a value of a TSF timer of the AP. Based on the beacon, a TSF value of the target device may be synchronized with the TSF value of the AP. Post the TSF synchronization, a target message may be transmitted by the target device to a network device.

In a number of embodiments, the process 600 may transmit another beacon to the network device (block 620). The network device may correspond to other APs, wireless stations, or the like, of a wireless network. The network device may act as a relay for AMP device energy harvesting and frame detection. Based on the beacon, a TSF value of the network device may be synchronized with the TSF value of the AP.

In a variety of embodiments, the process 600 may obtain, at the AP, a TSF value of the target device (block 630). In an example, the TSF value of the target device may be obtained via a probe request. In another example, the TSF value of the target device may be obtained via another target message.

In more embodiments, the process 600 may obtain, at the AP, from the network device, a timestamp value and an RSSI of the target message and a processing delay of the target device (block 640). The timestamp value may indicate a time-of-arrival of the target message, transmitted by the target device, at the network device. In still additional embodiments, when the timestamp value is obtained from the network device, the TSF value of the network device may be synchronized with the TSF value of the AP. The processing delay may correspond to the actual time duration between the TSF synchronization at the target device and the transmission of the target message by the target device.

In additional embodiments, the process 600 may determine a TSF error at the target device (block 650). The TSF error may be determined based on the TSF value of the target device, the processing delay, and the TSF value of the AP. The TSF error may be indicative of the difference in the TSF synchronization between the AP and the target device.

In further embodiments, the process 600 may determine a time-of-travel of the target message from the target device to the network device (block 660). The time-of-travel of the target message may be determined based on the timestamp value, the processing delay, and the TSF error at the target device. In some cases, the time-of-travel may be determined further based on the RSSI of the target message.

In still more embodiments, the process 600 may determine a distance between the target device and the network device (block 670). The distance between the target device and the network device may be determined based on the determined time-of-travel of the target message from the target device to the network device. The distance between the target device and the network device may be configured to facilitate the detection of a location of the target device in the wireless network.

Although a specific embodiment for determining a distance between a target device and a network device suitable for carrying out the various steps, processes, methods, and operations described herein is discussed with respect to FIG. 6, any of a variety of systems and/or processes may be utilized in accordance with embodiments of the disclosure. For example, distances between the target device and other network devices of the wireless network that receive the target message may be determined based on timestamp values, RSSIs, and processing delays determined by these network devices in a similar manner as described above. The elements depicted in FIG. 6 may also be interchangeable with other elements of FIGS. 1-5 and 7-10 as required to realize a particularly desired embodiment.

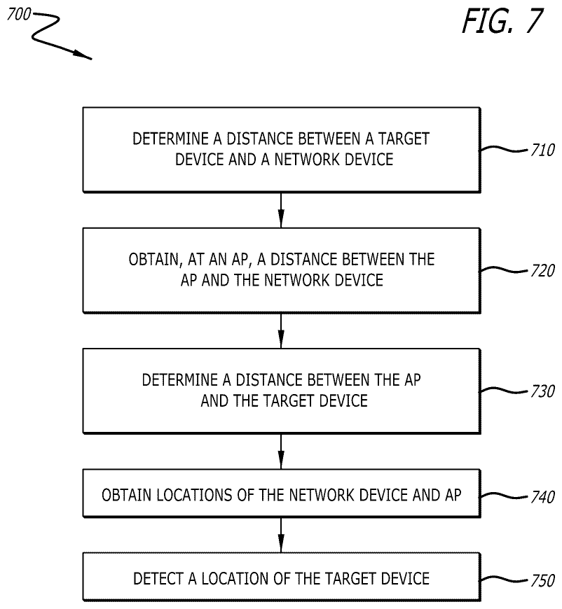

Referring to FIG. 7, a process 700 for locating a target device in a wireless network in accordance with various embodiments of the disclosure is shown. In many embodiments, the process 700 may determine a distance between a target device and a network device (block 710). The distance between the target device and the network device may be determined based on a time-of-travel of a target message from the target device to the network device. The time-of-travel of a target message may be determined based on a TSF error at the target device, a processing delay of the target device, and a time-of-arrival of the target message at the network device.

In a number of embodiments, the process 700 may obtain, at an AP, a distance between the AP and the network device (block 720). In still additional embodiments, the wireless network may include a database that may be configured to store the locations of all network devices and APs. The database may be accessed to obtain the distance between the AP and the network device.

In a variety of embodiments, the process 700 may determine a distance between the AP and the target device (block 730). The distance between the AP and the target device may be determined based on the determined distance between the target device and the network device and the obtained distance between the AP and the network device. In some more embodiments, the distance between the AP and the target device may be determined using a hyperbolic method.

In more embodiments, the process 700 may obtain locations of the network device and the AP (block 740). The database may be accessed to obtain the locations of the network device and the AP. Once the distances between all devices are determined and the locations of the network device and the AP are known, the location of the target device can be detected.

In further embodiments, the process 700 may detect a location of the target device (block 750). The location of the target device in the wireless network may be determined based on the location of the network device in the wireless network, the location of the AP in the wireless network, the distance between the target device and the network device, and the distance between the AP and the target device. The detected locations can be utilized to facilitate various operations at the target device. For example, the detected location of the target device may be utilized to determine whether a network device at a particular position has the AMP device in sight. Further, the detected location can be utilized to determine how to charge the target device (e.g., duration and source of the charging frames), to determine how to schedule medium access for the target device, to classify the target device into a geographical group, to position the target device on a floor map, or the like.

Although a specific embodiment for locating a target device in a wireless network suitable for carrying out the various steps, processes, methods, and operations described herein is discussed with respect to FIG. 7, any of a variety of systems and/or processes may be utilized in accordance with embodiments of the disclosure. For example, locations of other types of devices in a network may be determined in a similar manner as described above. The elements depicted in FIG. 7 may also be interchangeable with other elements of FIGS. 1-6 and 8-10 as required to realize a particularly desired embodiment.

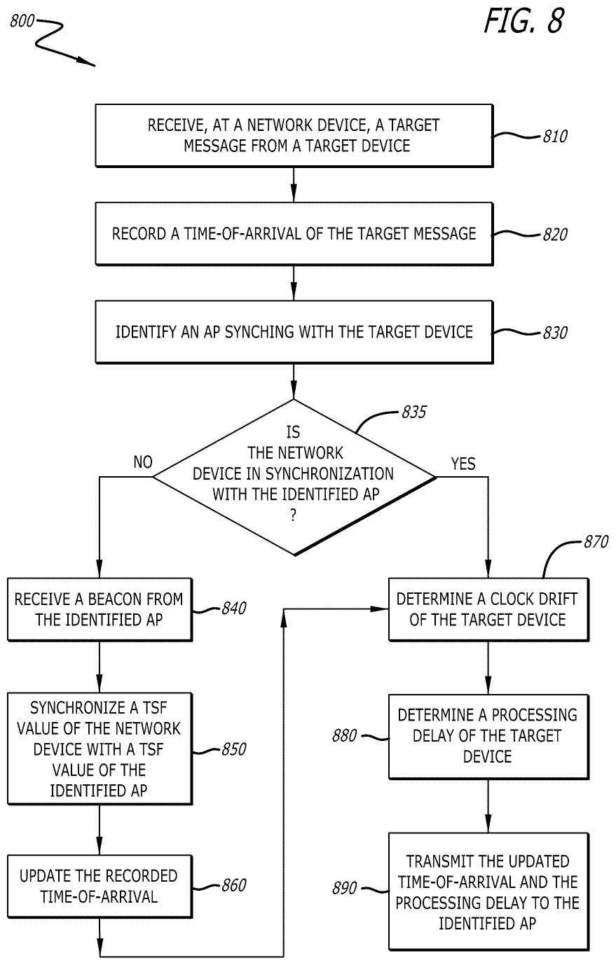

Referring to FIG. 8, a process 800 for facilitating target device location detection in accordance with various embodiments of the disclosure is shown. In many embodiments, the process 800 may receive, at a network device, a target message from a target device (block 810). The target device may correspond to an AMP device. The network device may correspond to other APs, wireless stations, or the like, of a wireless network. The network device may act as a relay for AMP device energy harvesting and frame detection.

In a number of embodiments, the process 800 may record a time-of-arrival of the target message (block 820). The time-of-arrival of the target message may be determined based on the TSF value of the network device. In an example, a message timestamp value indicating the time-of-arrival of the target message, from the target device, at the network device may be generated. The message timestamp value may have sub-nanosecond precision.

In a variety of embodiments, the process 800 may identify an AP synching with the target device (block 830). The target message may include an AP indicator configured to indicate the AP with whom the target device has synchronized. Examples of the AP indicator may include a BSSID of the AP, channel information of the AP, or the like. The AP synching with the target device may be identified based on the AP indicator.

In more embodiments, the process 800 may determine whether the network device is in synchronization with the identified AP (block 835). In additional embodiments, in response to determining that the network device is not in synchronization with the identified AP, the process 800 may receive a beacon from the identified AP (block 840). The beacon may be configured to indicate a TSF value of the identified AP.

In further embodiments, the process 800 may synchronize a TSF value of the network device with the TSF value of the identified AP (block 850). Thus, based on the AP indicator (e.g., the BSSID, the channel information, or the like, of the AP), the TSF value of the identified AP may be utilized for the synchronization of the TSF value of the network device. The TSF value of the network device may be required to be synchronized with the TSF value of the identified AP to prevent inaccuracies in target device location detection.

In still more embodiments, the process 800 may update the recorded time-of-arrival (block 860). The recorded time-of-arrival of the target message may be updated based on the synchronized TSF value of the network device. In an example, an updated message timestamp value indicating the time-of-arrival of the target message with respect to the AP may be generated.

In still further embodiments, the process 800 may determine a clock drift of the target device (block 870). In the wireless network, although various TSF timers are synchronized, all the TSF timers may not run at the same speed due to slight differences in their hardware and environmental conditions such as temperature changes. This may be referred to as a clock drift, where the clocks (e.g., the TSF timers) experience gradual deviation or variation from the accurate time over a period. The clock drift of the target device may be determined based on variations in various timing values recorded and/or included in multiple samples of the target message received at the network device. Also, in still additional embodiments, in response to determining that the network device is in synchronization with the identified AP, the process 800 may determine the clock drift of the target device (block 870).

In some more embodiments, the process 800 may determine a processing delay of the target device (block 880). The processing delay of the target device may be determined based on the clock drift of the target device. The processing delay may correspond to the actual time duration between TSF synchronization at the target device and the transmission of the target message by the target device.

In yet more embodiments, the process 800 may transmit the updated time-of-arrival and the processing delay to the identified AP (block 890). The updated time-of-arrival and the processing delay may be configured to facilitate the detection of the location of the target device in the wireless network. In an example, the updated time-of-arrival and the processing delay may be utilized to determine a distance between the target device and the network device. Further, the location of the target device in the wireless network may be determined based on the distance between the target device and the network device.

Although a specific embodiment for facilitating target device location detection suitable for carrying out the various steps, processes, methods, and operations described herein is discussed with respect to FIG. 8, any of a variety of systems and/or processes may be utilized in accordance with embodiments of the disclosure. For example, an AP may determine a processing delay of a target device. The elements depicted in FIG. 8 may also be interchangeable with other elements of FIGS. 1-7, 9, and 10 as required to realize a particularly desired embodiment.

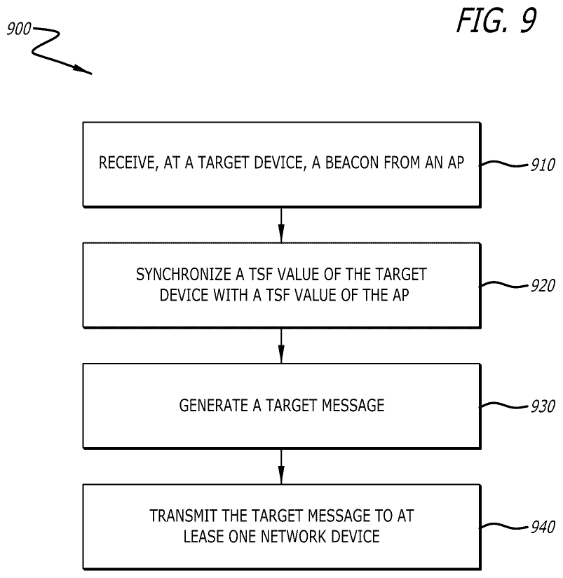

Referring to FIG. 9, a process 900 for target device processing in accordance with various embodiments of the disclosure is shown. In many embodiments, the process 900 may receive, at a target device, a beacon from an AP (block 910). The target device may correspond to an AMP device. The beacon may be configured to indicate a TSF value of the AP.

In a number of embodiments, the process 900 may synchronize a TSF value of the target device with the TSF value of the AP (block 920). In an example, the beacon may be transmitted by the AP at time “t” and the target device may receive the beacon at a time “t+dt”, “dt” being the time taken by the beacon to travel from the AP to the target device. However, as the beacon is indicative of the time “t”, the TSF value of the target device may be synchronized at the time “t” resulting in a “dt” error between the TSF value of the target device and the TSF value of the AP. The “dt” error can be referred to as a TSF error at the AMP device.

In a variety of embodiments, the process 900 may generate a target message (block 930). The target message may include a timestamp value that may be configured to indicate a time-of-sending of the target message. The timestamp value may thus be the current TSF value of the target device. The target message may also include an AP indicator configured to indicate the AP with whom the target device has synchronized. Examples of the AP indicator may include a BSSID of the AP, channel information of the AP, or the like. In some more embodiments, the target message may include one or more frames configured to indicate at least one timing attribute (e.g., the timestamp value, the AP indicator, or the like) of the target device. In yet more embodiments, the target message may correspond to a probe request configured to indicate the at least one timing attribute of the target device. In such a scenario, the probe request may include one or more IEs to indicate the at least one timing attribute of the target device.

In more embodiments, the process 900 may transmit the target message to at least one network device (block 940). In an example, if the target device has harvested enough energy, the target message may be transmitted more than one time to produce multiple samples of the target message at the buddy device. The transmission of the target message may be configured to facilitate the detection of the location of the target device in a wireless network.

Although a specific embodiment for target device processing suitable for carrying out the various steps, processes, methods, and operations described herein is discussed with respect to FIG. 9, any of a variety of systems and/or processes may be utilized in accordance with embodiments of the disclosure. For example, the target device may receive beacons or probe requests from various APs and may select one of the APs for the TSF synchronization. In such scenarios, the target message may include the AP indicator of the selected AP. The elements depicted in FIG. 9 may also be interchangeable with other elements of FIGS. 1-8 and 10 as required to realize a particularly desired embodiment.

Referring to FIG. 10, a conceptual block diagram for one or more devices 1000 capable of executing components and logic for implementing the functionality and embodiments described above is shown. The embodiment of the conceptual block diagram depicted in FIG. 10 can illustrate a conventional server computer, workstation, desktop computer, laptop, tablet, network appliance, e-reader, smartphone, or other computing devices, and can be utilized to execute any of the application and/or logic components presented herein. The device 1000 may, in some examples, correspond to physical devices or to virtual resources described herein.

In many embodiments, the device 1000 may include an environment 1002 such as a baseboard or “motherboard,” in physical embodiments that can be configured as a printed circuit board with a multitude of components or devices connected by way of a system bus or other electrical communication paths. Conceptually, in virtualized embodiments, the environment 1002 may be a virtual environment that encompasses and executes the remaining components and resources of the device 1000. In more embodiments, one or more processors 1004, such as, but not limited to, central processing units (“CPUs”), can be configured to operate in conjunction with a chipset 1006. The processor(s) 1004 can be standard programmable CPUs that perform arithmetic and logical operations necessary for the operation of the device 1000.

In additional embodiments, the processor(s) 1004 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In certain embodiments, the chipset 1006 may provide an interface between the processor(s) 1004 and the remainder of the components and devices within the environment 1002. The chipset 1006 can provide an interface to random-access-memory (“RAM”) 1008, which can be used as the main memory in the device 1000 in some embodiments. The chipset 1006 can further be configured to provide an interface to a computer-readable storage medium such as read-only memory (“ROM”) 1010 or Non-volatile RAM (“NVRAM”) for storing basic routines that can help with various tasks such as, but not limited to, starting up the device 1000 and/or transferring information between the various components and devices. The ROM 1010 or NVRAM can also store other application components necessary for the operation of the device 1000 in accordance with various embodiments described herein.

Different embodiments of the device 1000 can be configured to operate in a networked environment using logical connections to remote computing devices and computer systems through a network, such as the network 1040. The chipset 1006 can include functionality for providing network connectivity through a network interface controller (“NIC”) 1012, which may comprise a gigabit Ethernet adapter or similar component. The NIC 1012 can be capable of connecting the device 1000 to other devices over the network 1040. It is contemplated that multiple NICs 1012 may be present in the device 1000, connecting the device to other types of networks and remote systems.

In further embodiments, the device 1000 can be connected to a storage 1018 that provides non-volatile storage for data accessible by the device 1000. The storage 1018 can, for example, store an operating system 1020, applications 1022, and data 1028, 1030, and 1032, which are described in greater detail below. The storage 1018 can be connected to the environment 1002 through a storage controller 1014 connected to the chipset 1006. In certain embodiments, the storage 1018 can consist of one or more physical storage units. The storage controller 1014 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 1000 can store data within the storage 1018 by transforming the physical state of the physical storage units to reflect the information being stored. The specific transformation of physical state can depend on various factors. Examples of such factors can include, but are not limited to, the technology used to implement the physical storage units, whether the storage 1018 is characterized as primary or secondary storage, and the like.

For example, the device 1000 can store information within the storage 1018 by issuing instructions through the storage controller 1014 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1000 can further read or access information from the storage 1018 by detecting the physical states or characteristics of one or more particular locations within the physical storage units.

In addition to the storage 1018 described above, the device 1000 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1000. In some examples, the operations performed by a cloud computing network, and or any components included therein, may be supported by one or more devices similar to device 1000. Stated otherwise, some or all of the operations performed by the cloud computing network, and or any components included therein, may be performed by one or more devices 1000 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CDROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 1018 can store an operating system 1020 utilized to control the operation of the device 1000. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 1018 can store other system or application programs and data utilized by the device 1000.

In various embodiments, the storage 1018 or other computer-readable storage media is encoded with computer-executable instructions which, when loaded into the device 1000, may transform it from a general-purpose computing system into a special-purpose computer capable of implementing the embodiments described herein. These computer-executable instructions may be stored as applications 1022 and transform the device 1000 by specifying how the processor(s) 1004 can transition between states, as described above. In some embodiments, the device 1000 has access to computer-readable storage media storing computer-executable instructions which, when executed by the device 1000, perform the various processes described above with regard to FIGS. 1-9. In more embodiments, the device 1000 can also include computer-readable storage media having instructions stored thereupon for performing any of the other computer-implemented operations described herein.

In still further embodiments, the device 1000 can also include one or more input/output controllers 1016 for receiving and processing input from a number of input devices, such as a keyboard, a mouse, a touchpad, a touch screen, an electronic stylus, or other type of input device. Similarly, an input/output controller 1016 can be configured to provide output to a display, such as a computer monitor, a flat panel display, a digital projector, a printer, or other type of output device. Those skilled in the art will recognize that the device 1000 might not include all of the components shown in FIG. 10, and can include other components that are not explicitly shown in FIG. 10, or might utilize an architecture completely different than that shown in FIG. 10.

As described above, the device 1000 may support a virtualization layer, such as one or more virtual resources executing on the device 1000. In some examples, the virtualization layer may be supported by a hypervisor that provides one or more VMs running on the device 1000 to perform functions described herein. The virtualization layer may generally support a virtual resource that performs at least a portion of the techniques described herein.

In many embodiments, the device 1000 can include a location detection logic 1024 that can be configured to perform one or more of the various steps, processes, operations, and/or other methods that are described above. Often, the location detection logic 1024 can be a set of instructions stored within a non-volatile memory that, when executed by the processor(s)/controller(s) 1004 can carry out these steps, etc. In some embodiments, the location detection logic 1024 may be a client application that resides on a network-connected device, such as, but not limited to, a server, switch, personal or mobile computing device, or an access point.

In certain embodiments, the location detection logic 1024 may utilize TSF-based timestamping and relay by other network devices to detect the location of an AMP device. The location detection logic 1024 at an AP may be configured to transmit a beacon to an AMP device. The beacon may be configured to indicate a TSF value of the AP. The location detection logic 1024 at the AMP device may be configured to synchronize a TSF value of the AMP device with the TSF value of the AP. The location detection logic 1024 at the AMP device may be configured to generate a target message and transmit the target message to the buddy device.

The location detection logic 1024 at a buddy device may be configured to record a time-of-arrival of the target message based on a TSF value of the buddy device. The location detection logic 1024 at the buddy device may be configured to synchronize a TSF value of the buddy device with the TSF value of the AP. Based on the synchronized buddy TSF value, the location detection logic 1024 at the buddy device may be configured to update the recorded time-of-arrival of the target message. The location detection logic 1024 at the buddy device may be configured to determine a clock drift of the AMP device and determine a processing delay of the AMP device based on the determined clock drift. The processing delay may correspond to a time duration between the TSF synchronization at the AMP device and the transmission of the target message.

The location detection logic 1024 at the AP may be configured to obtain the TSF value of the AMP device, the timestamp value of the target message, and the processing delay of the AMP device determined at the buddy device. Based on the TSF value of the AMP device, the processing delay, and the TSF value of the AP, the location detection logic 1024 at the AP may be configured to determine a TSF error at the AMP device. The location detection logic 1024 at the AP may be configured to determine a distance between the AMP device and the buddy device based on the updated timestamp value, the processing delay, and the TSF error at the AMP device. The location detection logic 1024 at the AP may be configured to determine a distance between the AP and the AMP device based on the determined distance between the AMP device and the buddy device and a distance between the AP and the buddy device. Based on the location of the buddy device, the location of the AP, the distance between the AMP device and the buddy device, and the distance between the AP and the AMP device, the location detection logic 1024 at the AP may be configured to detect the location of the AMP device.

In a number of embodiments, the storage 1018 can include TSF data 1028. The TSF data 1028 may be configured to indicate the values of TSF timers of various devices in the network. The values of the TSF timers may experience variations due to slight differences in their hardware and environmental conditions such as temperature changes. The TSF data 1028 may also indicate the timestamp values utilized for each message, beacon, or probe request. These timestamp values may correspond to the values of the TSF timers at the time instances when messages, beacons, or probe requests are transmitted or received.

In various embodiments, the storage 1018 can include location data 1030. The location data 1030 may include locations of the network devices that are known. The location data 1030 may also include the location of the AMP devices that are detected using the locations of the known network devices.

In a number of embodiments, the storage 1018 can include AMP data 1032. The AMP data 1032 may indicate the amount of energy harvested by the AMP devices. The AMP data 1032 may also indicate the locations of the AMP devices that can be utilized for charging the AMP devices, determining the visibility of the AMP devices, or the like.

Finally, in many embodiments, data may be processed into a format usable by an ML model 1026 (e.g., feature vectors), and or other processing techniques. The ML model 1026 may be any type of ML model, such as supervised models, reinforcement models, and/or unsupervised models. The ML model 1026 may include one or more of linear regression models, logistic regression models, decision trees, Naïve Bayes models, neural networks, k-means cluster models, random forest models, and/or other types of ML models 1026. The ML model 1026 may be configured to learn clock drift patterns for AMP devices based on data related to historical clock drifts, and predict the clock drift. Such predictions may be utilized to reduce the number of samples of the target message that may be required at the buddy device to determine the processing delay of the AMP device.

The ML model(s) 1026 can be configured to generate inferences to make predictions or draw conclusions from data. An inference can be considered the output of a process of applying a model to new data. This can occur by learning from data and using that learning to predict future outcomes. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 1026 may be generated by human/administrator verifications or may compare predicted outcomes with actual outcomes.

Although a specific embodiment for a device suitable for configuration with a location detection logic for carrying out the various steps, processes, methods, and operations described herein is discussed with respect to FIG. 10, any of a variety of systems and/or processes may be utilized in accordance with embodiments of the disclosure. For example, the device 1000 may be in a virtual environment such as a cloud-based network administration suite, or it may be distributed across a variety of network devices or switches. The elements depicted in FIG. 10 may also be interchangeable with other elements of FIGS. 1-9 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
a network interface controller configured to provide access to a network; and
a memory communicatively coupled to the processor, wherein the memory comprises a location detection logic that is configured to:
obtain a timestamp value from at least one network device, wherein the timestamp value is configured to indicate a time-of-arrival of a target message, from a target device, at the at least one network device, and wherein the target device is associated with a processing delay;
determine a distance between the target device and the at least one network device based on the obtained timestamp value and the processing delay; and
detect a location of the target device in the network based on a location of the at least one network device in the network and the distance between the target device and the at least one network device.

2. The device of claim 1, wherein the target device corresponds to an ambient power device.

3. The device of claim 1, wherein prior to transmission of the target message, a timing synchronization function (“TSF”) value of the target device is synchronized with a TSF value of the device.

4. The device of claim 3, wherein the location detection logic is further configured to transmit, to the target device, a beacon that is configured to indicate the TSF value of the device.

5. The device of claim 3, wherein the processing delay corresponds to a time duration between the TSF synchronization at the target device and the transmission of the target message.

6. The device of claim 1, wherein a TSF value of the at least one network device is synchronized with a TSF value of the device.

7. The device of claim 6, wherein the location detection logic is further configured to transmit, to the at least one network device, a beacon that is configured to indicate the TSF value of the device.

8. The device of claim 1, wherein determining the distance between the target device and the at least one network device based on the obtained timestamp value and the processing delay comprises determining a time-of-travel of the target message from the target device to the at least one network device based on the obtained timestamp value and the processing delay, and wherein the distance between the target device and the at least one network device is determined based on the time-of-travel of the target message.

9. The device of claim 8, wherein the location detection logic is further configured to determine a TSF error at the target device, and wherein the location detection logic determines the time-of-travel of the target message further based on the TSF error at the target device.

10. The device of claim 9, wherein the location detection logic is further configured to obtain a TSF value of the target device, and wherein the location detection logic determines the TSF error at the target device based on the TSF value of the target device, the processing delay, and a TSF value of the device.

11. The device of claim 1, wherein the target message comprises one or more frames configured to indicate at least one timing attribute of the target device.

12. The device of claim 1, wherein the target message corresponds to a probe request configured to indicate at least one timing attribute of the target device.

13. The device of claim 1, wherein the location detection logic is further configured to obtain the processing delay associated with the target device from the at least one network device.

14. The device of claim 1, wherein the location detection logic further determines the distance between the target device and the at least one network device based on a received signal strength indicator (“RSSI”) of the target message.

15. The device of claim 1, wherein the location detection logic detects the location of the target device further based on a distance between the device and the target device.

16. The device of claim 15, wherein the location detection logic is further configured to:
obtain a distance between the device and the at least one network device; and
determine the distance between the device and the target device based on the determined distance between the target device and the at least one network device and the obtained distance between the device and the at least one network device.

17. A device, comprising:
a processor;
a network interface controller configured to provide access to a network; and
a memory communicatively coupled to the processor, wherein the memory comprises a location detection logic that is configured to:
receive a target message from a target device;
record a time-of-arrival of the target message based on a timing synchronization function (“TSF”) value of the device;
synchronize the TSF value of the device with a TSF value of a network device; and
update the recorded time-of-arrival of the target message based on the synchronized TSF value of the device, wherein the updated time-of-arrival of the target message is configured to facilitate detection of a location of the target device in the network.

18. The device of claim 17, wherein the location detection logic is further configured to determine a processing delay associated with the target device, and wherein the processing delay is configured to facilitate the detection of the location of the target device in the network.

19. The device of claim 17, wherein the target message is configured to indicate a basic service set identifier (“BSSID”) of the network device, and based on the BSSID of the network device, the TSF value of the network device is utilized for the synchronization of the TSF value of the device.

20. A method, comprising:
obtaining a timestamp value from at least one network device, wherein the timestamp value is configured to indicate a time-of-arrival of a target message, from a target device, at the at least one network device, and wherein the target device is associated with a processing delay;
determining a distance between the target device and the at least one network device based on the obtained timestamp value and the processing delay; and
detecting a location of the target device in a network based on a location of the at least one network device in the network and the distance between the target device and the at least one network device.
